(19) United States
(12) Patent Application Publication
(10) Pub. No.: US 2010/0262606 A1
(43) Pub. Date: Oct. 14, 2010

(54) Method for Scoring Content of Nodes in a Database

(75) Inventors: Toma Bedolla, Denver, CO (US); Brook Molla, Denver, CO (US)

Correspondence Address: Brook Molla, 1020 15th Street, Unit 7E, Denver, CO, 80202, US

(73) Assignee: VERACIOUS ENTROPY LLC, Denver, CO (US)

(21) Appl. No.: 12/760,216

(22) Filed: Apr. 14, 2010

Related U.S. Application Data
(60) Provisional application No. 61/169,069, filed on Apr. 14, 2009.

(51) Int. Cl. G06F 17/30

(52) U.S. Cl. 707/741; 707/748; 707/E17.044; 707/E17.002

(57) ABSTRACT

The following disclosure contains a method and system for establishing, maintaining, reporting and presenting data regarding the scoring of content and entities, specifically levels of veracity in information or content and the credibility of an evaluating entity or entities that communally determine this veracity. An aspect of the invention permits reporting on an active node, file or files with an associated communally derived veracity score. Scores can be filtered contextually allowing for veracity scores to reflect specific communal or contextual values which are likely to vary from general scores. Scores are generated through a weighted system of consumption, verifications and disputes. The weighted system is comprised of a communally derived credibility scores of each evaluating entity within the system. Evaluating entities are awarded credibility scores through communal verifications of authored public content, referential treatment to this public content as well as a demonstrated awareness of overall existing content.

### CROSS REFERENCE TO RELATED APPLICATION

This application claims priority under 35 U.S.C. §119(e) to U.S. Provisional Patent Application Ser. No. 61/169,069 filed Apr. 14, 2009, which is incorporated herein in its entirety by reference.

### TECHNICAL FIELD

This invention relates generally to the differentiation of articles or nodes within a database, linked or not and assigning accountability to entities interacting with those articles or nodes. More specifically, this pertains to methods for analyzing entity interactions with nodes in a database and scoring these nodes and entities according to these interactions, such as the world-wide web or any other type of community facing data store.

### BACKGROUND

The Internet has created an environment in which the barrier to publishing content and reaching a broad audience is incredibly low. Media agents, both public and private, are publishing web accessible content in such massive volume that determining the veracity of content on any web-site or page is extremely difficult, time consuming or both. The layers of content created by references to yet further unverified content yields a landscape that makes the veracity of information almost incapable of being substantiated by anyone who is not themselves a subject matter expert. Additionally, the sources of content and their historical accuracy in publishing content may be difficult to determine leaving issues of justification, data manipulation and bias as open questions.

### SUMMARY

The present invention provides a method and a system to utilize recursive relationships between various concepts as a means to create differentiation, with regard to veracity, between articles or nodes in a database or other means of storing data. More specifically, the present invention provides methods for communally scoring the veracity of content in articles of public information in various forms, documents on the web or some other community accessible collection of information (textual, graphical, pictorial, audible or otherwise, commonly referred to as content in media). One aspect of the invention establishes a process for determining an individual's credibility as it pertains to the authoring, exchange or consumption of public media. Another aspect of the invention provides a technique for filtering the values used in differentiation, contextually or generally. Additional aspects of the invention, definitions of relevant concepts and the relationships between them will become apparent in the following description and associated figures.

One aspect of the invention is to determine the accuracy of a public form of media through communal consumption, verifications or disputes of its content. By leveraging the collective knowledge set of a community, content is verified for accuracy or truth and given a score that indicates the content's veracity. Intuitively, the more verifiable the content of a document, the more accurate it is deemed to be. Another aspect of the invention involves collecting consumer verifications or disputes of public content, persisting the relationship between consumer and content, and archiving these relationships and evaluations in a database. Alternatively, the consumer may take a neutral stance by consuming but not acting upon the content.

The veracity of authored content can be considered to be a direct reflection on the credibility of the author with respect to an intent or ability to convey truth. Another aspect of the invention is to track the veracity of an author's work as an indication of an author's credibility, especially within a given context. The greater the accumulative veracity of an author's previous work, the more credible the author is considered to be within the system. Any entity within the system can be considered an author, as verifications, disputes and comments on content are themselves subject to the same method of scoring content by the community.

Entities gain and lose credibility within the system as a function of various concepts. Those concepts are the previously mentioned method of communally scoring veracity of authored content, the referential treatment of authored content and a demonstrated level of awareness of overall content, both generally and contextually within the system. The more an author's content is cited by other authors, either as a reference or as a justification, the greater the referential value the content warrants and consequently some portion of that value is attributed to an increase in the cited author's credibility. The invention, in addition to tracking relationships of consumers to content, also includes methods for tracking relationships of content to other content within a database.

The present invention consists of a method for estimating an entity's awareness. Effectively the more information or content an entity consumes in conjunction with interactions (verifying or disputing content), the greater the potential credibility granted to the entity, either contextually or generally. A greater awareness represents a broader understanding of relationships or potential relationships of content with other nodes of content. When authoring or exchanging content for publishing, being aware of the potential impact within and across contexts can expedite the process of determining the accuracy of said content and is rewarded within the system.

Additional aspects, applications and advantages of the present invention will become apparent in the following detailed descriptions and associated figures.

### BRIEF DESCRIPTION OF THE DRAWINGS

The present invention is illustrated by way of example and not limitation in the figures of the accompanying drawings, in which like references indicate similar elements, and in which,

FIG. 1 is a diagram of a server/computer that operates the present method.

FIG. 2 is a flowchart of established relationships between entities and content.

FIG. 3 is a diagram of verifications and disputes associated with a node or article of content in one embodiment of the invention.

FIG. 4 is a diagram of references between nodes or articles of content in accordance with the invention.

### DETAILED DESCRIPTION

Although the following detailed description contains various specifics for the purposes of illustration, the term “veracity” is used to represent general concepts reflecting the evaluated conformity with truth and/or information accuracy. Similarly, the term “credibility” is used to reflect concepts associated with the trustworthiness of an entity in publishing content as well as an entity's ability to judge and evaluate content. The term “awareness” is used to represent the relative scope of content consumption by an entity to other entities. The term “referential” is used to convey explicit or implicit, direct or indirect references made to content by referral content. A person having ordinary skill in the art will recognize that the term “database” is used to generalize any type of data store and the term “content” is used to represent labels generally applied to nodes of information, linked or not, in a data store (i.e., nodes, articles, documents, pages etc.) while the term “computer” represents any medium that stores instructions executable by one or more processors to perform the present method. Additionally, “content” may include, but is not limited to, a single article of content, a portion of content, multiple articles of content, a single article of content chosen by at least one entity, and multiple articles of content chosen by at least one entity. Types of content can include, but are not limited to, textual, graphical, audible, pictorial, and video formats. An entity can include, but is not limited to, individuals, groups of individuals, organizations or associations, groups of organizations, associations, automated evaluators of content and non-automated evaluators of content, an automated system or a subset of any of these groups. Accordingly, the following embodiments of the invention are set forth without any loss of generality to, and without imposing limitations upon, the claimed invention.

Content that is generated, published or uploaded to the web or any other public facing database and thus made accessible to any entity other than the authoring entity, is open to various forms of evaluation by the consuming entity or entities of said content. These evaluations of content establish an implicit set of relationships between the authoring entity, the consuming entity and the content itself. There can be many types of relationships, including but not limited to, authoring, referencing, consuming or evaluating. These relationships can be quantified algorithmically in order to determine scores that indicate the credibility of the authoring entity, the credibility of the evaluating entity and the veracity of the content authored and evaluated.

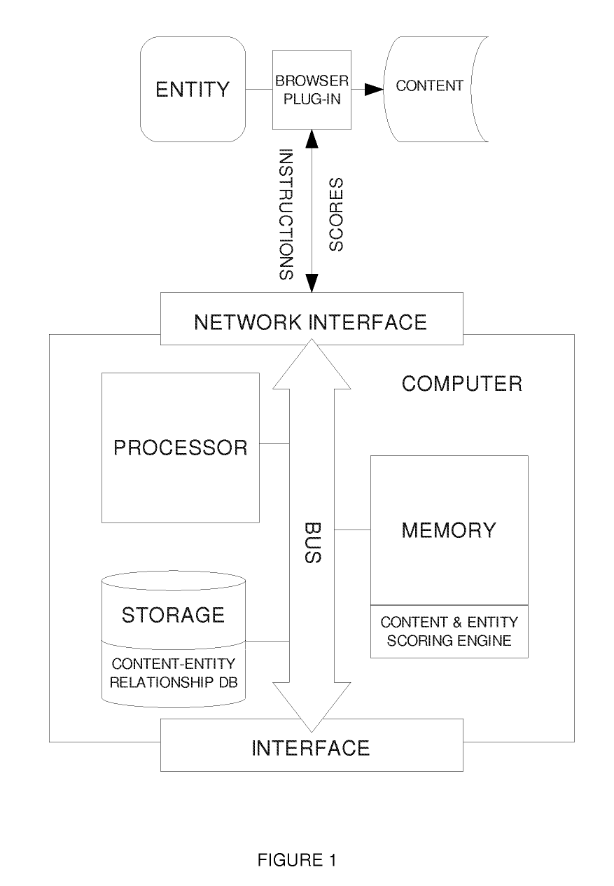

FIG. 1 illustrates how a computer receives requests for scores, generates scores or updates relationships between entities and content. In the figure, the Entity views some Content through a Browser (or any other information viewing technology). The Browser contains a plug-in that sends Instructions, related to the Entity and/or the Content, containing requests, updates or both, to a Computer via some network through a Network Interface. The Instructions are transferred along the Bus to the Processor that reads and executes the Instructions. This can include generating, updating or acquiring Scores in the Content & Entity Scoring Engine located in Memory via the Bus, updating Content-Entity Relationship database that maintains relationships used for calculations performed in the Content & Entity Scoring Engine that is in the Storage via the Bus or both. Scores relating to the Content are returned to the Processor to be transferred through the Network Interface across some network to the Browser that sent the Instructions.

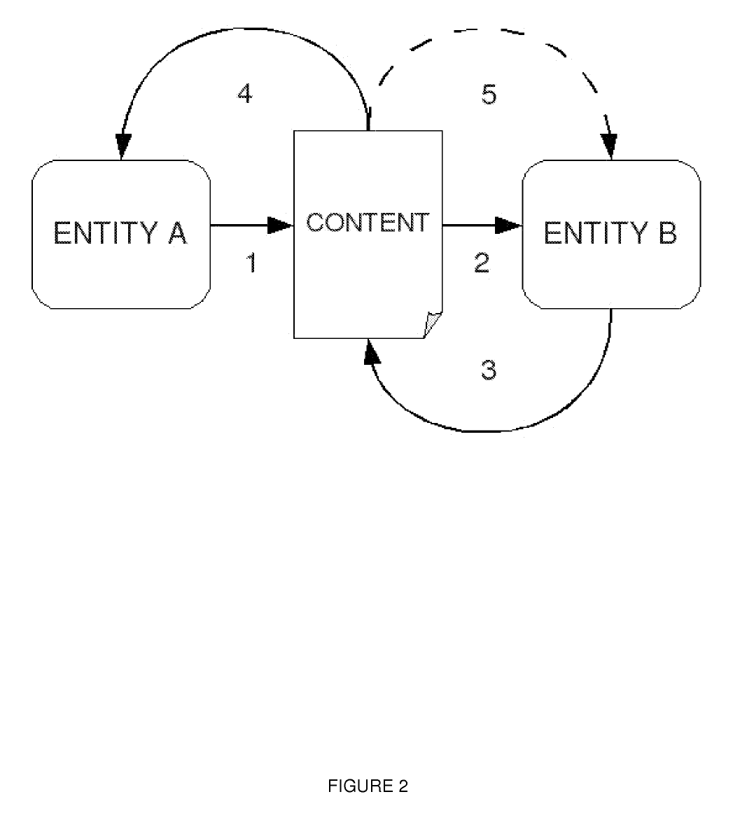

FIG. 2 illustrates the relationship between two entities, Entity A and Entity B, and a node, the Content. As shown in FIG. 2, Entity A generates and publishes (1) the Content to some public facing database and is thus made accessible to Entity B. Entity A therefore has a relationship (4) with the veracity score of the Content. Should Entity B consume the Content a relationship between Entity B and the Content (2) will also be established. An evaluation (3) by Entity B of the content in the Content impacts the veracity score of the Content. Any change in the veracity score of the Content affects the credibility of Entity A. In a special case, Entity B may also have a relationship (5) with the veracity score of the Content. Each of these relationships are explained in further detail later in the description.

According to one embodiment of the present method of measuring veracity, evaluations of content are weighted at least in part by the credibility associated with the evaluating entity. Algorithmically, the veracity of the content in the Content is defined according to the present invention as

$$V = \frac{v ( {C}_{i} ) - d ( {C}_{j} )}{v ( {C}_{i} ) + d ( {C}_{j} )}$$

where ‘v’ and ‘d’ represent one or more validating and invalidating relationship types, functions of the credibility values associated with the evaluating entities (Cᵢ and Cⱼ) that establish these relationships. If an entity consumes some content and subsequently chooses to validate or invalidate the content, then the entity commits at least some portion of the credibility with which it is associated towards the evolving veracity value of the content within the system. In order to convey the iterative relationship between veracity and credibility consistent with the present invention, we must include a general algorithmic definition of an entity's credibility

$$C = 1 + ( 1 + A ) \times {\sum }_{x = 0}^{∞} ( {V}_{x} \times ( 1 + {R}_{x} ) )$$

where ‘A’ is the awareness value associated with the entity, ‘Vₓ’ represents the veracity score of authored content ‘x’ by the entity and ‘R_{X}’ is the referential value of the same authored content. For simplicity, we set A=0 and R=0 for all entities. The present method essentially provides a relationship between the credibility of an entity and how other entities, along with their own credibilities, align themselves by taking a validating, invalidating or neutral stance with regard to the authored content of said entity. As the veracity scores of the entity's evaluations and authored content increase, so does the entity's credibility score and similarly as the veracity scores decrease so too does the entity's credibility score decrease. Current content scoring systems utilize a numbered or vote total rating system that promotes a content's likely exposure, but reflects nothing with respect to the veracity of the content, the credibility of the author or the credibility of the evaluator. This basic content scoring system is simply

S(content)=v−d

where scoring of content is based on a vote up, ‘v’, or vote down, ‘d’. This type of content scoring system is susceptible to the random effects of popularity as each vote either counts equally with no accountability imposed on the participants, or each vote is explicitly weighted by the voting party within a scale, a 5 star scale for example, again with no accountability imposed on the participants. The present method provides a more sophisticated means in scoring content in addition to filtering the effects of popularity. Evaluations that verify or dispute content must stand alone, as authored content, subject to the same scrutiny as the content evaluated. A specific implementation allows for alternative evaluation types, providing entities the ability to leverage their credibility for or against the veracity of content through agreements or disagreements. In FIG. 2, the dashed line from the Content back to Entity B illustrates this type of relationship where the credibility of the evaluating entity, not just the authoring entity, is tied to subsequent movements in the veracity of the Content. This provides the system with the means to weight future evaluations made by an entity according to the credibility earned as a result of the veracity and type of past evaluations.

There are no limits on how positive or negative an entity's credibility may become, thus giving a single entity the ability to serve as a counter measure to popularity in the promotion or demotion of content. This allows for unlimited differentiation across an unlimited number of entities within the system. Contrarily, a limited interval for veracity scores (−1, 1) makes it possible to compare various articles of content within and across contexts. In practice, there are thousands to millions of articles of content as well as thousands to millions of entities capable of evaluating that content, thus providing an example that conveys the nature of the system through inspection is not possible. In order to illustrate the ebb and flow between values of credibility and veracity, consider the singular example illustrated in FIG. 2. Let's assume values for both entities' credibilities (C(A)=4.1 and C(B)=22.2) and the veracity of the content of the Content (V=0.428; v=75, d=30) where the credibility of Entity A, C(A) already accounts for the present value of V (0.4285). Now, if Entity B were to evaluate the Content (3) and chose to validate the contents as true (verify, agree, etc.) then the value of V becomes

$$V = \frac{( 75 + 22.2 ) - 30}{( 75 + 22.2 ) + 30} = 0.5283$$

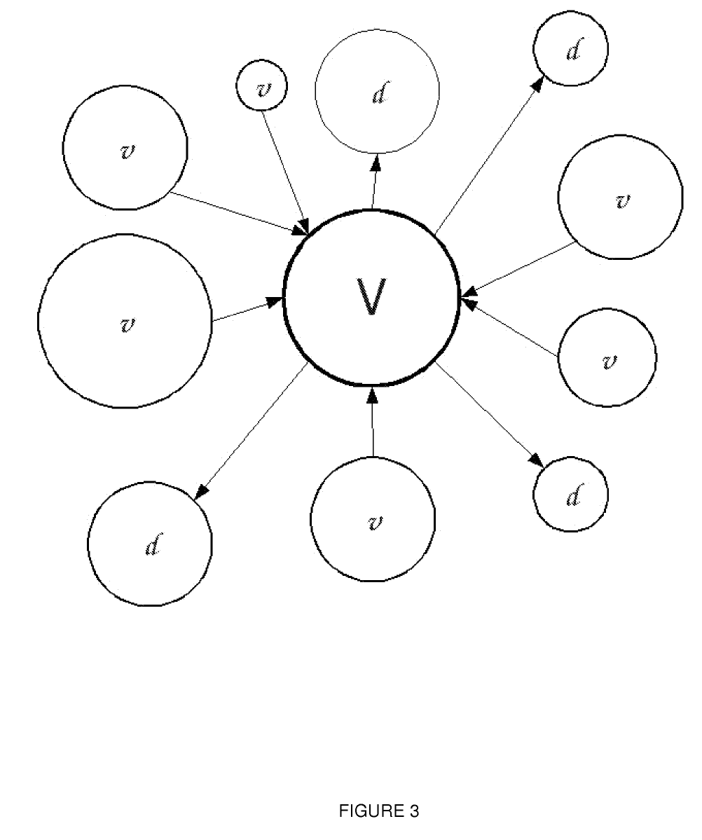

and thus the updated veracity score for the Content is V=0.5283. An update to credibility scores yields Entity A with a new credibility score of 4.2, or a 2.4% increase as a result of the increase in the veracity of the Content. Similarly, upon the next iteration of veracity and credibility calculations, any evaluations made by Entity A will reflect this updated credibility score (4.2) accordingly. FIG. 3 represents a snapshot of a random node at any given time, where validating relationships (v) contribute to the overall veracity of the node and invalidating relationships (d) reduce the amount of veracity associated with the node, each according to the respective credibilities of the entities associated in those relationships. This basic example and figure illustrate how credibility and veracity scores evolve within the system. In practice, it will require a modest number of iterations, generally less than 10¹ to allow veracity and credibility values to reach a steady state, as each validating or invalidating relationship is itself a node. Regardless of how large, positively or negatively, credibility scores become, the first degree effects on the authors of evaluated nodes is always mitigated by the limited range of possible veracity scores, −1 to 1. This protects the system from any selective favoritism by the most credible entities.

The previous example was simplified in order to convey the present method's circular relationship between credibility and veracity. Omitted from the previous example is the present method's slightly more complex means of determining an entity's credibility, including methods for determining referential values of authored content and the demonstrated awareness of an entity within the system. The referential value of an entity's authored content is an accumulated portion of positive veracity scores earned by referral content, where referral content is any node that references an entity's authored content in support of its own content, that is credited to the value of the referenced content's contribution towards the authoring entity's credibility. A basic referral contribution is calculated as

$$R = \frac{{V}_{referral}}{{r}_{referral}}$$

where ‘r’ is the number of references made by the referral content. These contributions of a referral's veracity score allotted to the author of the referenced content's credibility can be altered as function of the number of references made by both the referral and the referenced content.

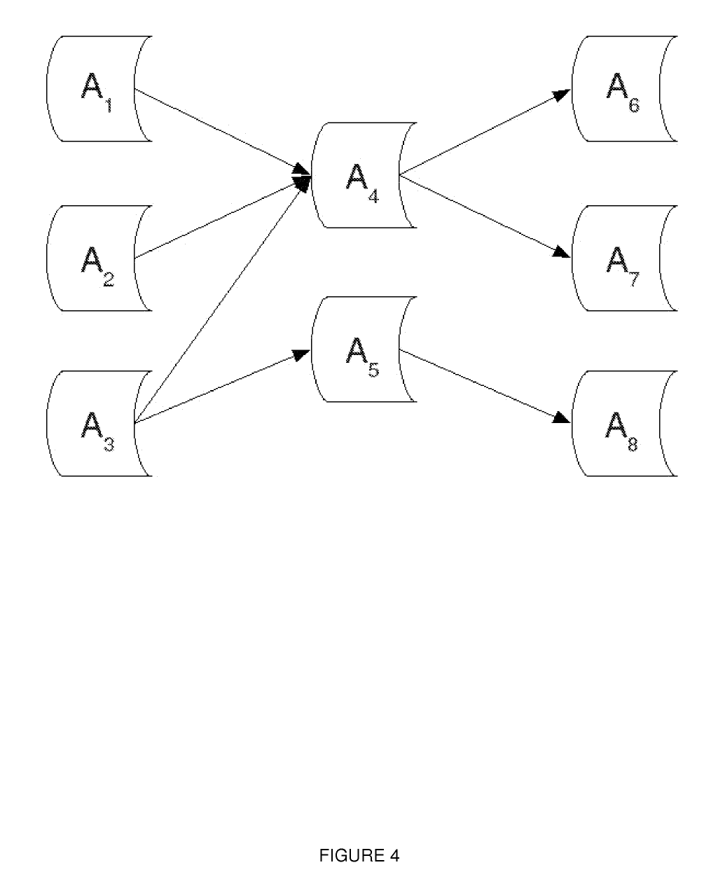

FIG. 4 shows a typical relationship between several nodes or articles of content that make references to other nodes or articles. In the figure, articles A₁₋₃ all reference A₄ and in accordance with the present method are considered referrals. A₄ in turn references both A₆ and A₇, such that A₄ is both referenced content and referral content. Similarly, A₅ is the referenced content of A₃ and a referral to A₈. Articles A₄₋₈ have the potential for referential values within the system. Referential values provide additional contributions towards an entity's credibility, serving as a multiplier of the accumulative veracity contribution of any authored content. This essentially rewards authors of content that spawns, supports or clarifies other content, more specifically additional content with positive veracity when calculating credibility.

In one particular embodiment of the present invention, a method for measuring the awareness of an entity within the system is included in the calculation of the entity's credibility. The value of awareness within the system is to serve as a multiplier for the combined accumulation of veracity scores and their referential multipliers. Awareness can be interpreted as an entity's ability to recognize relationships between disparate nodes of content, thus increasing the likelihood of exposing the meaningful implications and potential conflicts of new content. Within the system, awareness is based primarily on an entity's content consumption and/or production and the veracity of that content relative to the total veracity of all content within the system

$$A = \frac{\sum \vert {V}_{entity} \vert}{\sum \vert {V}_{system} \vert}$$

By taking the absolute value of all veracities, the system makes no distinction between positive or negative scores when considering how aware an entity is within the system. One implementation of the present method's quantification of awareness includes the consumption of popular or highly consumed content with unknown or less frequently consumed content. Awareness is a relative term within the system, where each entity's awareness score depends on the production and consumption of other entities. For example, if all entities within the system consume or evaluate a particular node or article of content, then all entities are considered aware of this node's content and no relative advantage is gained by any one entity. Contrarily, if half of the system's entities consumed or evaluated a particular node's content, then the awareness of the consuming entities is greater than those entities that did not consume or evaluate the node's content. Again, no differentiation in awareness would result between those entities that did consume or evaluate the node's content.

The present invention allows for entities to have at least one or more preferences and at least one or more social networks in addition to associating content with at least one or more contexts. A “social network” may include, but is not limited to, a group of entities that has selected its members explicitly, a group of entities that has selected its members implicitly, a group of entities that share an interdependency or communal trait, and a group that has been identified by an external entity to the group itself. As a result, each score may be calculated within or without at least one context, within or without at least one social network or some combination of both. Consistent with the present invention, there are several ways that these methods for determining veracity, credibility, referentiality and awareness can be adapted or altered for various purposes. Entities may filter relationships as a means of gaining insight into the influences of biases, opinions or cultures on the veracity scores of content. Suppose a particular social network identifies itself as being entirely atheist. As a preference, an entity may choose to exclude that social network when processing veracity scores of content within a religious context. For a systemic example, content used in calculating awareness could be divided into two types, evaluated and consumed, where the consumed content's contribution to an entity's awareness score expires with time for all entities.

Contexts associated with content as well as adaptations and alterations to the calculating and reporting of veracity scores can be defined and utilized by at least one entity, social network or both. Similarly, contexts associated with content as well as adaptations and alterations to the calculating and reporting of veracity scores can be generated and utilized by the entire system. As entities define new contextual or social filters, it will be necessary to create and maintain indexes of veracity and credibility scores relative to these new filters. Maintaining and updating indexes of commonly requested contextual or socially filtered scores will yield the system more responsive to trends in processing demands. One implementation of the present method adjusts the frequency in which these indexes are updated, and thus the resources, allotted to a particular index within the system, in accordance to the level of demand for the scores contained in these indexes. For example, as requests for scores within a given index diminish, the frequency in which that index is updated will be reduced accordingly, freeing system resources such as processor and memory. While indexing is standard practice in expediting the processes of retrieving and performing calculations on data sets, the demand driven indexing of the present method is considerably more subtle and complex as it automates and adjusts these processes. Entity interactions both expand the number of indexes managed by the system as well as determine the processing schedules for those indexes, thus allowing the system to respond and adapt to demand as efficiently as possible.

Another important application and embodiment of the present invention entails the ability to leverage an entity's scores when making evaluations of content beyond the scope of the system directly associated with calculating those scores. One implementation allows external domains or systems(domains or systems other then the domain or domains, system or systems managed directly by the present invention) to access scores when authorized by the entities to which those scores belong. A person having ordinary skill in the art will recognize that the terms “domain” and “system” refers to domains within a system as in web domains on the Internet as well as domains on disparate or disconnected systems like a private network or database. Another implementation provides external domains the ability to not only access an entity's scores, but to collaborate with the system to provide the data necessary to contribute to the evolution of those scores. This type of portability not only permits open participation with the system by current and future domains and systems, but allows entities the ability to apply relationships initiated in other domains towards their scores. Open implementations provide entities the means to leverage the relationships they develop with content beyond the scope of the system itself, encouraging participation and increasing value and accuracy of the scores these relationships develop for all entities.

All of the previous methods, embodiments and implementations listed above, individually and in concert, are part of a system designed to score content and entities in order to assist entities in facing the challenge of determining the veracity of the content consumed everyday. Making the search for truth a collaborative effort, the system encourages and rewards entities that engage in the dialog. It will be clear to one skilled in the art that the above methods, embodiments and implementations may be adapted and altered in many ways without departing from the scope of the invention. Accordingly, the scope of the invention should be determined by the following claims and their legal equivalents.

We claim:

1. A computer-readable medium that stores instructions executable by at least one processing device to perform a method for determining at least one score for at least one content and at least one entity comprising of:
obtaining a plurality of relationships established by at least one entity and at least one content in a database;
assigning an evaluation score to each of the plurality of relationships based upon an evaluation type; and
processing at least one score for the at least one content and the at least one entity based upon the evaluation score of each of the plurality of relationships.

2. The method of claim 1 wherein the at least one score is processed for the at least one content and wherein the score is selected from the group consisting of a veracity score and a referential score.

3. The method of claim 1 wherein the at least one score is is processed for the at least one entity and wherein the at least one score is selected from a group consisting of a credibility score and an awareness score.

4. The method of claim 1 wherein the plurality of relationships are selected from the group consisting of evaluating, reviewing, authoring, consuming, and referencing; and wherein the evaluation type is at least one selected from the group consisting of verifying, refuting, disputing, affirming, denying, agreeing, disagreeing and recommending.

5. The method of claim 1 wherein the plurality of relationships, the evaluation score and the at least one entity within one domain or a system are applicable across multiple related domains or systems or unrelated domains or systems.

6. The method of claim 1 wherein the at least one entity is at least one selected from the group consisting of individuals, groups of individuals, organizations or associations, groups of organizations, associations, automated evaluators of content and non-automated evaluators of content.

7. The method of claim 1 wherein the at least one content is evaluated as at least one of:
a single article of content;
a portion of content;
multiple articles of content;
a single article of content chosen by the at least one entity; and
multiple articles of content chosen by the at least one entity.

8. The method of claim 7 wherein at least one format of the content is at least one selected from the group consisting of textual, graphical, pictorial, audible and video.

9. The method of claim 1 wherein the at least one entity is at least one social network.

10. The method of claim 1 wherein the at least one content is within at least one context.

11. The method of claim 1 wherein the at least one content is within at least one context and the at least one entity is a social network.

12. The method of claim 2 wherein for processing the veracity score, the at least one content is within at least one context and the at least one entity is a social network.

13. The method of claim 3 wherein for processing the credibility score, the at least one content is within at least one context and the at least one entity is a social network.

14. The method of claim 3 wherein the at least one score is the credibility score, and wherein at least one score is a plurality of scores, wherein the plurality of scores of previously authored content by the at least one entity;
and processing the credibility score for the at least one entity based upon the plurality of scores, and wherein the plurality of scores are selected from the group consisting of an awareness score processed for the at least one entity and a referential score processed for the content.

15. The method of claim 1 wherein the at least one score is processed for the at least one content and wherein the score is a credibility score for the at least one entity; wherein the at least one score are a plurality of veracity scores, wherein the plurality of veracity scores of previously authored and evaluated content by the at least one entity; and processing the credibility score for the entity based upon the plurality of veracity scores.

16. The method of claim 13 wherein processing the credibility score further comprising:
adjusting the at least one score based upon the plurality of relationships; and
processing the credibility score.

17. The method of claim 10 wherein the contexts is at least one selected from the group of relating the at least one content explicitly, relating the at least one content implicitly and relating the at least one content behaviorally.

18. A computer-readable medium that stores instructions executable by at least one processing device to perform a method for identifying an entity comprising of:
obtaining a plurality of relationships established by an entity capable of producing, evaluating, or consuming content and content in a database and
identifying the entity by at least one of these relationships, all of these relationships, relationships within one or more contexts, relationships within one or more social networks or some combination of relationships within one or more contexts and one or more social networks.

19. The method of claim 18 wherein the entity's identity within one domain or system is applicable across multiple related or unrelated domains or systems.

20. The method of claim 1 wherein the at least one content is ranked according to the at least one score.

21. The method of claim 1 wherein the at least one entity is ranked according to the at least one score.

22. The method of claim 1 wherein the at least one content is filtered by the at least one score.

23. The method of claim 1 wherein the at least one entity is filtered by the at least one score.

24. A computer-readable medium that stores instructions executable by at least one processing device to perform a method for determining at least one score for at least one content and at least one entity comprising of:
obtaining a plurality of relationships established by at least one entity and at least one content in a database;
assigning an evaluation score to each of the plurality of relationships based upon an evaluation type;
processing at least one score for the at least one content and the at least one entity based upon the evaluation score of each of the plurality of relationships; and
indexing the at least on score for the at least one content and the at least one entity.

25. The method of claim 24 wherein the at least one score is processed for the at least one content and wherein the score is selected from the group consisting of a veracity score and a referential score.

26. The method of claim 24 wherein the at least one score is is processed for the at least one entity and wherein the at least one score is selected from a group consisting of a credibility score and an awareness score.

27. The method of claim 24 wherein the plurality of relationships are selected from the group consisting of evaluating, reviewing, authoring, consuming, and referencing; and wherein the evaluation type is at least one selected from the group consisting of verifying, refuting, disputing, affirming, denying, agreeing, disagreeing and recommending.

28. The method of claim 24 wherein the at least one entity is at least one social network.

29. The method of claim 24 wherein the at least one content is within at least one context.

30. The method of claim 24 wherein the index further comprises:
associating a processing schedule for the index, wherein the index is dependent upon a frequency of requests by the at least one entity for the at least one score contained in the index.
